(19) United States
(12) Patent Application Publication
(10) Pub. No.: US 2003/0126560 A1
(43) Pub. Date: Jul. 3, 2003

(54) Adaptive bookmarking of often-visited web sites

(75) Inventors: Kaushal Kurapati, Yorktown Heights, NY (US); Srinivas Gutta, Yorktown Heights, NY (US); Miroslav Trajkovic, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/034,660

(22) Filed: Dec. 28, 2001

(51) Int. Cl. G06F 7/00

(52) U.S. Cl. 715/514

(57) ABSTRACT

A process for adaptive bookmarking of often-visited web sites, comprising the steps of (a) optionally determining the identity of a particular user, (b) determining whether a webpage has been detected, (c) if the webpage in step (b) has been detected, determining whether the webpage has been previously visited by a particular user, (d) performing one of (i) creating an initial record of the webpage visit by the particular user if it has been determined in step (c) that the webpage has not been previously visited by the particular user, and (ii) determining whether the webpage has been previously bookmarked if it has been determined in step (c) that the webpage has been previously visited by the particular user, (e) updating a visitation count if it has been determined in step (c) that the webpage has been previously visited by the particular user, (f) determining whether the visitation count has reached a predetermined threshold; and (g) recommending the bookmarking of the address of the webpage if it determined in step (f) that the predetermined threshold of the visitation count has been reached. The visitation count may be number of plural visits and time spent visiting. The system may either automatically purge bookmarks or do so by recommendation after non-use for predetermined periods of time. A system includes hardware plus a program module to perform the bookmarking functions.

### BACKGROUND OF THE INVENTION

1. Field of the Invention

The present invention relates to web sites on the Internet. More particularly, the present invention relates to bookmarking web sites that are visited by users for return visits.

2. Description of the Related Art

The Internet provides a user with information that is in the form of web pages. Web page data is downloaded from a web site using standard protocols, including, but not limited to, Transmission Control Protocol/Internet Protocol (TCP/IP). TCP and IP are two separate protocols used together. The IP utilizes a packet-addressing method wherein any computer on the Internet that is closer to the packet's recipient is permitted to forward the packet. The TCP ensures data transmission reliability across networks connected in the Internet. Web pages are found by addresses called Universal Resource Locators (URL's).

Conventional web browsers, such as Microsoft's Internet Explorer and Netscape Navigator provide the user with the tools to view the webpage, browse between previous pages and subsequent pages, and “bookmark” favorite pages. The bookmarking allows the user to go right back to the exact same page of a web site, which may not be the “homepage” of a web site, but rather could be a subsequent page or pages from the home page. This saves time in typing in the address of the homepage of the web site, followed by clicking the mouse on links, which is often in the form of a hypertext mark-up language (such as HTML, DHTML, or XML), and wasting the time and computing resources of loading pages that are not of interest, only to get to a certain desired page.

However, the bookmarking of favorite pages has to be affirmatively acted on by the user, and often as a user is browsing, it is common to forget that a certain page or pages should be bookmarked as a favorite page. In fact, users sometimes report that they are sometimes not sure how they reached a certain webpage, and may not be able to retrace steps to get back.

There has been an attempt in the prior art to solve this problem, as disclosed by Bates, U.S. Pat. No. 6,100,890, which is hereby incorporated by reference as background material. In this prior art patent, Bates discloses automatically bookmarking a website based on the duration of time a person views it during a session, or by the user entering words describing their tastes that are stored in a folder to see if the words (or their equivalent via a Thesaurus) are matched.

The first problem with the disclosure by Bates is that a person could get a phonecall, or walk away from the computer, or be distracted by some other means, and have the web page automatically bookmarked. Also, even though the user might have been reading a particular page for a certain period of time, doesn't mean that they want the page bookmarked, but once they meet the criteria in a global setting mode, it will be bookmarked. This is particularly true if they are concerned about privacy, because they might leave footprints on the computer showing sites that, not only do they visit, but find to be favorites, which can be a source of embarrassment or worse.

Similarly, the use of a Thesaurus to find matching keywords means that the user has to answer questions about likes and dislikes, and many pages could be bookmarked that are not exact matches. Also, even if the user, for example, specifies they like football, that does not necessarily mean they want every webpage that mentions football bookmarked. In addition, sometimes an article can use the keywords and still not actually be discussing that subject. For example, O. J. Simpson was a former star football player, and while that is often mentioned in articles about him, most writings about him over the last six years are not discussing his history as a star football player. Yet, these articles could be bookmarked because they match the keywords entered by the user.

The result of using the automatic bookmarking system as disclosed by Bates is a very cluttered group of bookmarks, many of which are not relevant to what the user considers a favorite. This system causes the user to have to screen the browser and erase webpages, but he/she would have to go back and visit the webpages to see if they want to keep them, which is not very time efficient.

### SUMMARY OF THE INVENTION

Accordingly, it is an object of the present invention to provide an automatic plug in module that will keep track of user visits to selected web sites and automatically prompt a user as to whether or not they wish to bookmark the webpage as a favorite, so that the user can return to the page saving a series of steps. Alternatively, after a certain threshold of visits have occurred, the user will be presented with a message requesting whether or not they wish to bookmark this site.

According to an aspect of the present invention, a process for adaptive bookmarking of often-visited web sites comprises the steps of:

A process for adaptive bookmarking of often-visited web sites, comprising the steps of:

(a) determining whether a webpage has been detected;

(b) if the webpage in step (a) has been detected, determining whether the webpage has been previously visited by a particular user;

(c) performing one of (i) creating an initial record of the webpage visit by the particular user if it has been determined in step (b) that the webpage has not been previously visited by the particular user, and (ii) determining whether the webpage has been previously bookmarked if it has been determined in step (b) that the webpage has been previously visited by the particular user;

(d) updating a visitation count if it has been determined in step (b) that the webpage has been previously visited by the particular user;

(e) determining whether the visitation count has reached a predetermined threshold; and

(f) recommending to the user that the webpage be bookmarked if it determined in step (e) that the predetermined threshold of the visitation count has been reached.

The process may further include the step of (g) prompting the particular user to indicate as to whether it is desired to bookmark the address of the webpage.

The process may further include that, in response to an indication by the user desiring a bookmark, (g) proceeding to bookmark the address of the webpage.

The recommending and the prompting can be a visual display, or an audio prompt to the user. The user indication can be a mouse click, keystroke, voice command, physical gesture, etc.

The visitation count threshold can be a plurality of visits, or a combination of a plurality of visits and a predetermined amount of time spent on the web page, which can be a total aggregate time, an average time, or a mean time.

Alternatively, the bookmarking can be automatic (without user recommendation or prompt) if there are multiple visits to the same page that reach the threshold. The bookmarking may also be automatic if there is a combination of more than one visit to the web page, and a combination of a time threshold, which may aggregate, average, mean, etc.

According to another aspect of the present invention, a process for adaptive bookmarking of often-visited web pages of a web site comprises the steps of:

(a) determining a particular user of a browser;

(b) determining whether the browser has been previously bookmarked for a web page of a web site presently accessed by the particular user of the browser;

(c) determining whether a record count exists for visits to the web page by the particular user if the browser has not been bookmarked;

(d) if it is determined in step (c) that the record count exists, updating the record count to reflect the present access by the particular user, and creating an initial record count if it is determined in step (c) that no record count exists for the present webpage being accessed by the particular user;

(e) determining whether the record count has reached a predetermined threshold of visitation;

(f) prompting the user as to whether it is desired to bookmark the webpage if it is determined in step (e) that the threshold has been reached; and

(g) bookmarking the webpage if the user responds affirmatively to step (f).

The determination of the identity of the particular user can be by any known method, such as speech recognition, or a camera positioned to capture an image of the user.

According to still another aspect of the present invention, a system for bookmarking often-visited web sites comprises:

a computer having storage;

a browser program in communication with the computer;

a communication means for the computer to communicate with a network;

the browser includes a program module that:

(i) determines whether a web site accessed by a particular user has been previously bookmarked, and whether a record exists if the web site has not been previously bookmarked;

(ii) creates a record count identifying the web site accessed being by the particular user; and

(iii) bookmarks browser to provide a short cut to the web site if a predetermined threshold of visitation has been reached by the particular user.

Alternatively, the user in step (iii) may receive a recommendation to bookmark the site, and they can make the bookmark manually. Or, the user in step (iii) may alternatively be prompted as to whether they wish to bookmark the web site, and the bookmark can be made by the system after the user indicates a desire to bookmark.

In addition, the process and system can, after a predetermined period of time, prompt the user with regard to bookmarked web pages that have not been revisited after a certain period of time and recommend their removal. The user can be prompted as to whether they wish to system to remove the bookmark of the web page. Alternatively, the user can set a threshold that requests automatic deletion of the bookmark if the web page is not revisited after a certain number of days, weeks, months, years, or number of sessions using the browser without revisiting the page.

### BRIEF DESCRIPTION OF THE DRAWINGS

It should be understood by persons of ordinary skill in the art that the bookmarking module according to the present invention is not limited to any particular type of browser, or any particular type of operating system. For example, while there are common browsers for personal computers such as Internet Explorer and Netscape, the present invention can be used with browsers made by others.

Moreover, there is no requirement as to operating system, for example, the browser does not have to operate on Windows, Apple operating systems, IBM OS2, etc. The invention can operate on any browser that operates under an operating system, or as the case may be, will operate on browsers that could be considered separate operating systems, or integral to an operating system, as the case may be. The invention can be applied to networks other than the Internet (such as LAN, WAN, or even a future replacement of the current Internet), and is not limited to personal computers. The end user could be using a palm-operated device, pager/telephone with Internet or other network type access. Moreover, the bookmarked pages do not have to be stored at the user end, and can remain in storage by the network.

### BRIEF DESCRIPTION OF THE DRAWINGS

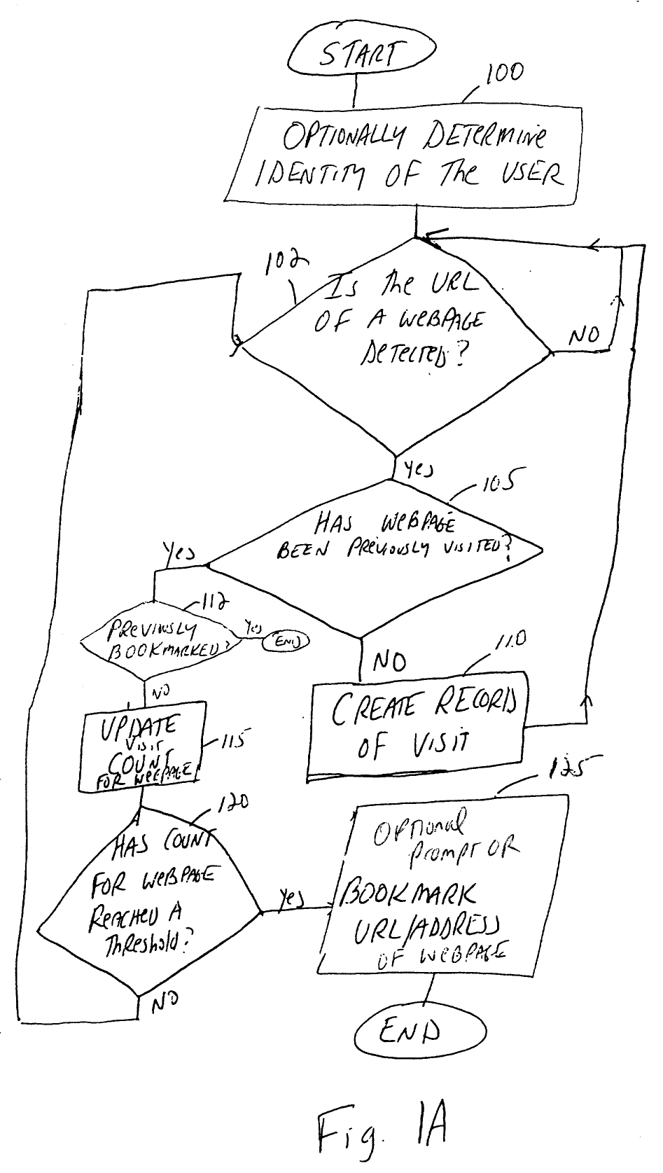

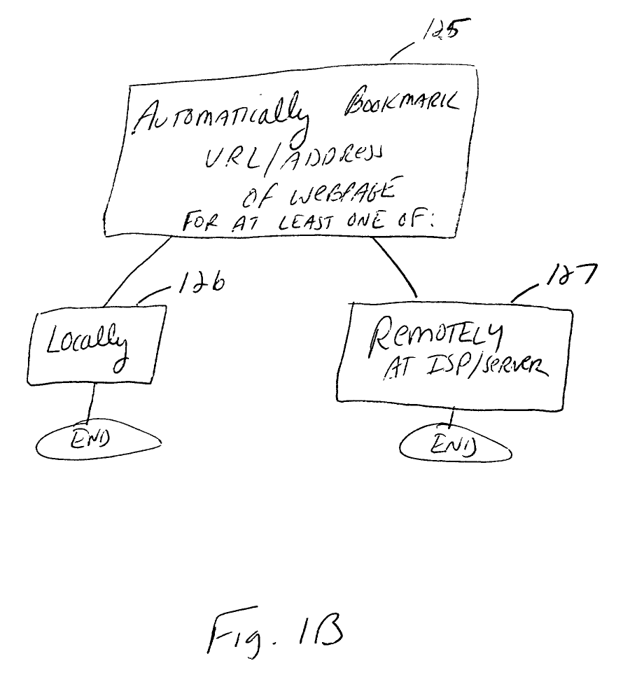

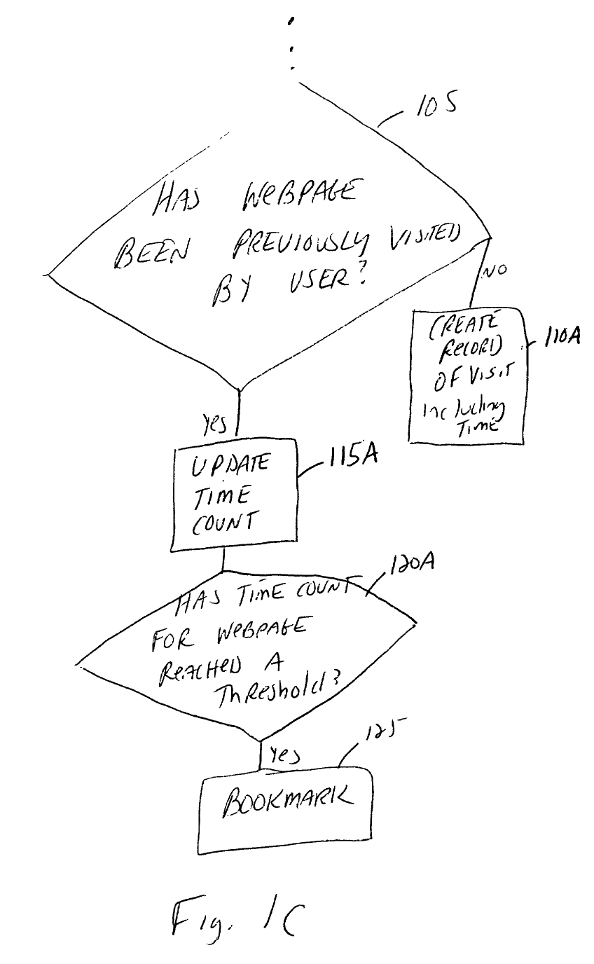

FIG. 1A is a flowchart illustrating a first aspect of the present invention.

FIG. 1B illustrates a variation in the process of adaptive bookmarking shown in FIG. 1A.

FIG. 1C illustrates another aspect of the present invention, wherein the amount of time is used for setting a threshold for bookmarking.

FIG. 1D lists some of the ways that can be used for setting a threshold according to the present invention.

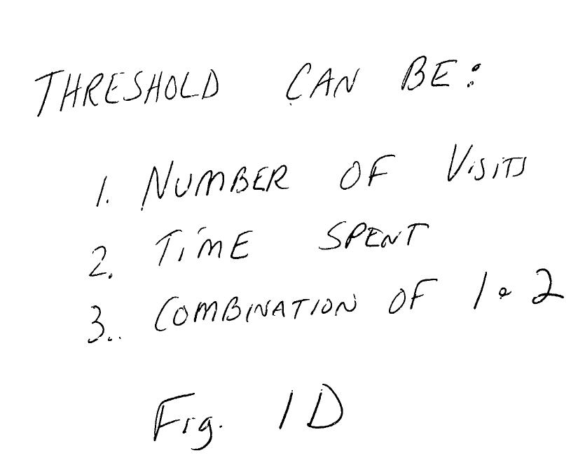

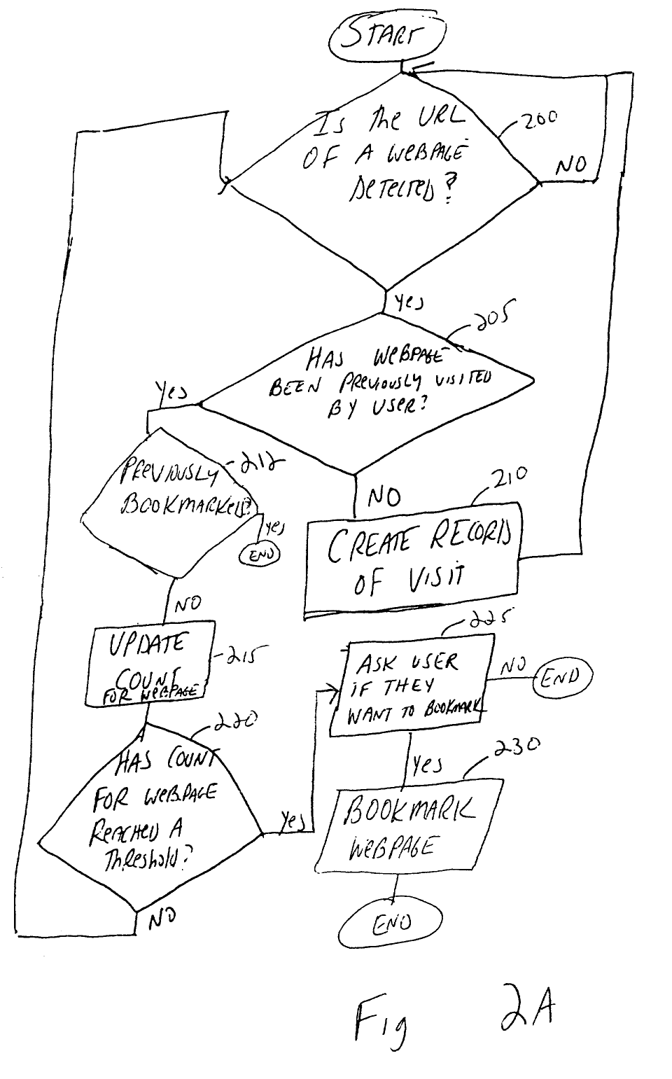

FIG. 2A is a flowchart illustrating yet another aspect of the present invention.

FIG. 2B illustrates a variation in the process illustrated in FIG. 2A.

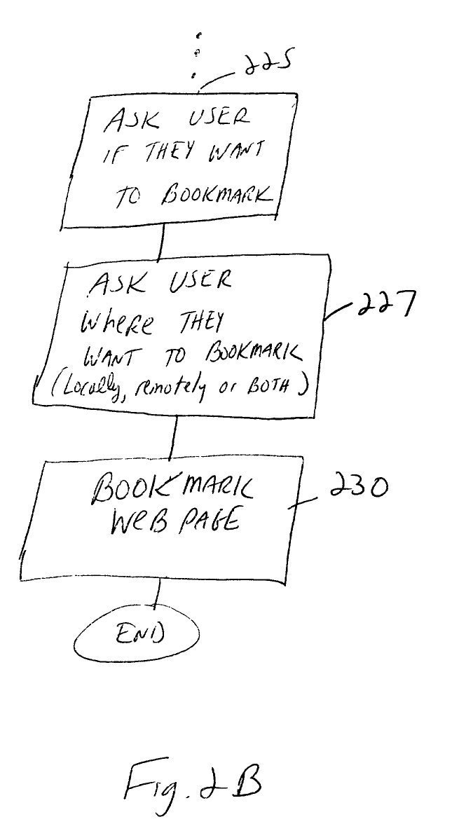

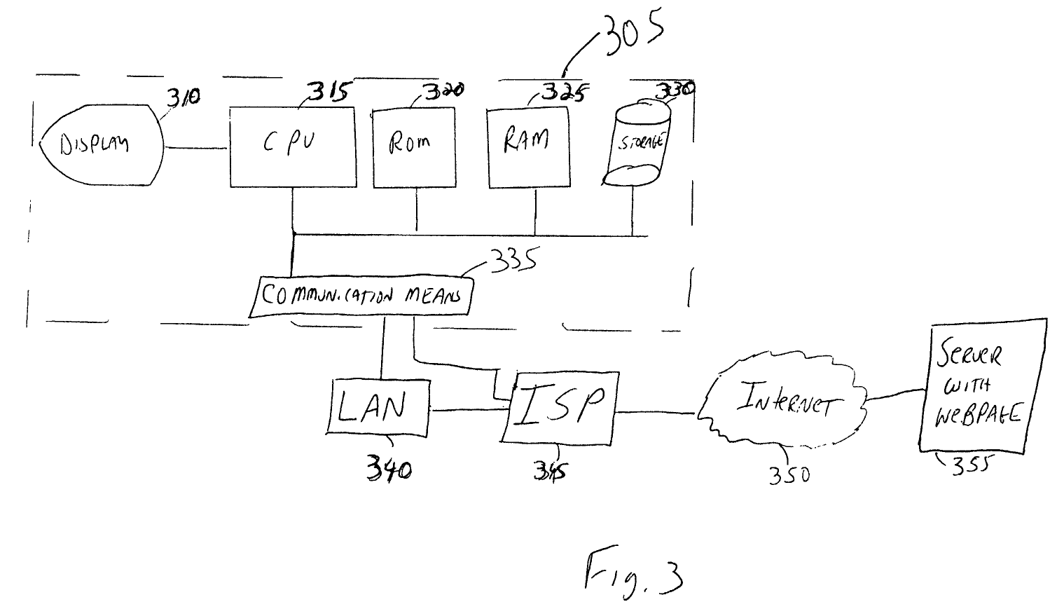

FIG. 3 depicts an overview of a system according to the present invention.

### DETAILED DESCRIPTION OF THE PREFERRED EMBODIMENTS

It should be understood by persons of ordinary skill in the art that the descriptions contained herein are presented for purposes of illustration and not for limitation, and there are many modifications that can be made that are within the spirit of the invention and the scope of the appended claims.

FIG. 1A is flowchart to illustrate a first aspect of the process according to the present invention.

At step 100, the identity of particular user is determined. It should be noted by persons of ordinary skill in the art that step 100 is an optional enhancement of the present invention, but is not required. If there is no determination of the particular user, then the bookmarkings would be machine dependent, rather than based on a particular user. The ability to logically separate different bookmarkings for different users of a computer can be done in a number of ways.

The reason it would be desirable to identify the user is to be able to logically separate the bookmarkings of different users can be by password and/or id protection, which is known in the art. This would allow for more privacy, as other users would not be able to see what sites have been bookmarked by other users, plus it would reduce the clutter caused by varying tastes of different users.

One way to identify the user can be by speech recognition, or a camera can capture the image. The identification of the image captured by the capturing means, preferably by facial recognition. U.S. Pat. No. 6,137,896 to Chang et al., and U.S. Pat. No. 5,991,429 to Coffin, et al. are hereby incorporated by reference as background material as two types of facial recognition which can be used with the recognition aid of the present invention.

In addition, biometric identification, such as the kind where a pattern of a person's eye (iris detection) is used for identification, can also be used as a way to identify the particular user. U.S. Pat. No. 4,641,349 to Flom et al. and U.S. Pat. No. 6,119,096 to Mann et al. are hereby incorporated by reference as background material for iris detection systems that can be used with present invention. Speech recognition may also be used for identification, and such systems for identification are known in the art. Of course, fingerprints, palm prints and even grip recognition could be used.

Identification by password could be made by the Internet Service Provider. There area already such identification systems which permit the browser to have logical separations for each user's tastes. For example, America Online® has a function called “Favorite Places”©, which allows users to manually bookmark favorite sites. As America Online® allows as many as seven users (or more in later planned versions) to use a particular computer as their “home” or “other” location, each of the users has a set of favorite places that is seen only by that user, and such access to the Favorite Places is permitted only after the successful presentation of a password accepted by the ISP. Accordingly, the present invention could be adapted to update the logically separate “Favorite Places©” of each user. Alternatively, the browser could request a password and make an identification at the user end. It should also be understood that the previous description is not limited to user by America Online®, and could be applied to the system of any Internet Service Provider.

At step 102, it is determined whether the URL/address of a webpage has been detected. This would typically begin by the user either typing in an address of a web site, or clicking on HTML. Until the user is accessing a web site, the process is essentially waiting for the user.

At step 105, the webpage accessed by the user is checked to determine whether it has been previously accessed. This previous access can be stored in a table kept by the browser, or accessed from storage on a user's hard drive. It is also possible for the server of the Internet Service Provider to track visits, and store the access history remotely. In addition, the browser can create a type of “cookie” on a first visit, the first visit being determined by checking whether a cookie has been previously created for the webpage. If there is no cookie for the webpage (meaning the webpage has not been previously visited) create a cookie for the visit. This cookie can be separate and apart from any cookie that a particular web site leaves on a user's system.

At step 110, a record of the visit is created if it has been determined at step 105 that the webpage has not been previously visited by a user. At this stage, the process goes back to step 100 and would continue to create records of first time visits.

At step 112, in response to the determination that this was not the first visit to a particular webpage, it is determined whether the webpage has already been bookmarked. If it has, the process ends for this particular webpage. If step 110 were to be eliminated, there would need to be the determination as to whether or not there is a bookmark for the webpage, then the determination as to whether a record has been created for the particular webpage without a bookmark. Otherwise, a record could be created each time the determination was made that the particular web site was not bookmarked.

Step 115 is followed if the determination at step 105 is affirmative, meaning that the webpage has been previously visited by the user. The visitation count is increased to reflect the latest visit.

At step 120, it is determined whether the visitation count, which was increased at step 115, has now reached a threshold. If a threshold has not been reached, the process goes back to step 100 and continues to detect webpages and determined if they have been previously visited by the user.

At step 125, in which the determination in step 120 has been affirmatively made that the visit count has reached a threshold (this threshold is a predetermined value), there is an automatic bookmarking of the url/address of the webpage. The webpage will now appear under a lists of favorites/bookmarked sites of the user's browser. Thus, an inexperienced user would be able to have a favorite webpage saved. In order to key the user in, it is optional, but desirable to notify the user with a message stating something akin to “this page has been automatically bookmarked to facilitate future access.”

FIG. 1B shows that the bookmark can be made in more than one location. For example, while the bookmark can be made locally on the user's browser (typically stored on their harddrive), the bookmark could be stored remotely, for example, on the network server. This would permit a user to be signed on to any computer in the network and have access to the bookmarked page if he/she should be sitting at a different computer. Alternatively, or in addition to storage locally and at the server, the Internet Service Provide can also make the bookmarks available. This availability would provide a user with the capability to have the favorites bookmarked no matter what computer they are using, whether that be someone else's on loan, a notebook/laptop while traveling, or a spare computer, either at different location or backup site.

FIG. 1C illustrates a variation of the flowchart in FIG. 1A, wherein the counts are according to time spent viewing webpages, rather than a simple visit count. For example, at step 105, it is determined whether the webpage has been previously visited by a user.

If this is the first visit by the user, at step 110A, a record count is created including the amount of time that a user spends with the webpage displayed.

However, if this is a repeat visit by the user, then at step 115A, a time count is updated. At step 120A, it is determined whether the time count for a webpage has reached a predetermined threshold. If the threshold has been reached, the webpage can be automatically bookmarked.

The amount of time required to reach a threshold can be calculated in a number of ways. A first way is simple addition of time for each visit, and when the sum is large than a predetermined threshold, there is an automatic bookmarking.

Another way to reach the required time threshold could be an average time, or a mean time of user viewing. The software, may, for example, throw out time counts where the viewing time is less than a predetermined number of seconds. If a user doesn't like a webpage, or doesn't find the information useful, there would be a greater tendency to page forward and look for elsewhere. Conversely, if a user spends more time viewing a particular webpage, there is a much greater tendency that the information on the page is more meaningful to the user. Time thresholds can also reduce the possibility of having too many bookmarks, which can not only overload system resources, but in fact present a user with too many choices.

FIG. 1D illustrates that a threshold does not have to be a pure count, or amount of time. There can be a combination of the number of visits, and the time spent, which can be used as a basis to set the predetermined thresholds. For example (the numbers are purely provided for explanatory purposes, and in no way should be meant to provide some boundary of thresholds) the threshold can be five visits. Alternatively, the threshold can be five minutes of viewing. Or, the threshold can be one of five visits and five minutes. Or, the threshold can be one of three visits where a total viewing time is an average of two minutes, or three visits where the mean time is one minute. In other words, the number of visits and the time spent viewing could be mixed and matched according to need.

FIG. 2A is a flowchart illustrating yet another aspect of the present invention, which contrasts with the automatic bookmarking in FIG. 1A.

At step 200, it is determined whether the url/address of a webpage has been detected.

If the webpage is detected, at step 205, it is determined whether the webpage has been previously visited by the user.

At step 210, an initial record is created logging in the visit if this was the first time the webpage has been visited by the user. As previously discussed, this record would typically be created by a plug-in module of the browser, and the record would be stored locally, typically on a user's harddrive. However, the record can be stored by a server on a local network, or by the Internet Service Provider of the user to access the Internet.

At step 212, in response to the determination that this was not the first visit to a particular webpage, it is determined whether the webpage has already been bookmarked. If it has, the process ends for this particular webpage. If step 110 were to be eliminated, there would need to be the determination as to whether or not there is a bookmark for the webpage, then the determination as to whether a record has been created for the particular webpage without a bookmark. Otherwise, a record could be created each time the determination was made that the particular web site was not bookmarked.

Step 215 updates the count for the webpage if the determination at step 205 is that the webpage has been previously visited by the user.

At step 220, it is determined whether the updated count has reached a threshold. If the threshold has been reached, the user is asked whether they want to bookmark the particular webpage. Alternatively, a message indicating that bookmarking of this webpage is recommended, click on yes to confirm, or no to disregard would be possible options.

Step 225 is where the bookmarking takes place after the user has indicated a desire to do so in response to a system indication.

If the user does not wish to bookmark the webpage, the browser may reset all the counts for that particular webpage, and/or erase the initial record, because it is unlikely that the user wants to bookmark this site in the future. Accordingly, the entire process would need to be carried out again to reach the threshold.

Alternatively, the count can continue, and the user could be asked whether they wish to bookmark, or whether bookmarking is recommended, every single time they access the webpage beyond a certain threshold, or at intervals, e.g. every other time they access the webpage over the threshold. The user could also be presented with an option where he/she could choose “do not show me this message again for this webpage”, and that would override the process. If such an option is available, once a webpage is detected, it could be checked as to whether the web address has been previously indicated as not desired for bookmarking.

FIG. 2B indicates another aspect of the invention, where the user would be asked as to where they want the webpage bookmarked. It could be bookmarked locally in the user device, at the network server, or by the Internet Service Provider. As previously discussed, there are advantages for bookmarking remotely as well as locally. Alternative to the query at the time of a threshold be triggered for bookmarking, a software plug-in module for this invention could ask the user during set up how they would wish the automatic bookmarking to be stored.

However, according to this aspect of the present invention, the bookmarking is recommended to the user, or the user is asked whether they wish to bookmark.

FIG. 3 illustrates a system according to the present invention. The user (shown as 305) typically would be communicating via a personal computer having a display 310, cpu 315, ROM 320, RAM 325, storage 330, and a communication means 335, such as a modem or network card. It should be understood by persons of ordinary skill in the art that the present invention should not be limited to a personal computer, because all of the above items could be part of an Internet-capable telephone, Television, Set Top Box and/or palm unit. The communication could be wire, wireless, fiber optic, LAN/WAN, etc. The type of communication could be DSL, IDSN, in fact, any protocol that can be used in a network environment.

The storage 330 would typically contain a browser which has the software module (not shown) permitting the process of adaptive bookmarking according to the present invention. Alternatively, this browser could be on a network (LAN 340) and/or ISP 345. While Internet Explorer and Netscape have been mentioned, any browser known heretofore, or invented in the future, can be modified in accordance with the present invention.

The server with the webpage 355 would be accessed via the Internet 350. As previously discussed, the present invention could be used on networks other than the Internet. When the bookmarking has reached a threshold as previously discussed, the browser residing in storage 330 can be updated with a bookmarked webpage. Optionally, in addition to, or lieu thereof, LAN 340 and/or Internet Service Provider 345 can be updated with the bookmarked page for user jointly and/or severally.

It is understood by persons of ordinary skill in the art that the connections between all the items shown in FIG. 3 can be modified as needed, and can be wired, wireless, fiber-optic, may be scrambled, etc. Also, the thresholds for bookmarking can be as previously discussed, or in the case of the user attachment to a LAN/WAN environment, bookmarking could be made available for the ease of others to use. In such cases, it would be prudent to affirm that the user wants the page bookmarked. In addition, the user can be prompted to enter a nickname for the bookmark to permit fast and easy recognition at a later date. Moreover, it is within the spirit and the scope of the invention that the browser may purge bookmarks if the site are no longer visited, or the frequency of visits drops below a certain threshold. In such cases, it would be prudent to prompt the user before deleting the bookmark, and indicate if the user wishes to continue to bookmark the webpage. This option would help to free up system resources if there are unused bookmarks taking up too much storage on the user system and/or network or ISP. It is also understood by persons of ordinary skill that an artisan can provide a program module to an existing browser known in the art, or add the feature of the present invention to a browser under development or to be developed in the future, without undue experimentation.

What is claimed is:

1. A process for adaptive bookmarking of often-visited web sites, comprising the steps of:
(a) determining a particular user of a browser;
(b) determining whether the browser has been previously bookmarked for a web page of a web site presently accessed by the particular user of the browser;
(c) determining whether a record count exists for visits to the web page by the particular user if the browser has not been bookmarked;
(d) if it is determined in step (c) that the record count exists, updating the record count to reflect the present access by the particular user, and creating an initial record count if it is determined in step (c) that no record count exists for the present webpage being accessed by the particular user;
(e) determining whether the record count has reached a predetermined as threshold of visitation;
(f) prompting the user as to whether it is desired to bookmark the webpage if it is determined in step (e) that the threshold has been reached; and
(g) bookmarking the webpage if the user responds affirmatively to step (f).

2. The process according to claim 1, wherein the determination of the particular user is made by speech recognition.

3. The process according to claim 1, wherein the determination of the particular user is made by prompting for at least one of a password and user identification.

4. The process according to claim 1, wherein the determination of the particular user is made by a capturing an image of the particular user by a camera, and comparing with images of authorized users in a storage area.

5. The process according to claim 4, wherein the camera captures an image of the user's iris, and identification by iris detection is performed.

6. The process according to claim 1, further comprising:
(h) prompting the particular user to indicate as to whether it is desired to bookmark the address of the webpage.

7. The process according to claim 6, wherein in response to an indication by the user desiring a bookmark, (i) proceeding to bookmark the address of the webpage.

8. The process according to claim 1, wherein the predetermined threshold of the visitation count in step (f) consists of a tally of visits by the user to the webpage.

9. The process according to claim 1, wherein the predetermined threshold of the visitation count in step (f) comprises a combination of (i) the visitation count comprising more than one visit by the particular user; and (ii) a total aggregate time spent viewing the webpage.

10. The process according to claim 1, wherein the predetermined threshold of the visitation count in step (f) comprises a combination of (i) the visitation count comprising more than one visit by the particular user; and (ii) a an average time spent viewing the webpage.

11. The process according to claim 1, wherein the predetermined threshold of the visitation count in step (f) comprises a combination of (i) the visitation count comprising more than one visit by the particular user; and (ii) a mean of the time spent viewing the webpage.

12. The process according to claim 1, wherein the predetermined threshold in step (f) is set by the particular user.

13. The process according to claim 1, wherein the bookmarking in step (g) is performed locally in a storage area communicating with a browser of the particular user.

14. The process according to claim 1, wherein the bookmarking in step (g) is performed remotely in a storage area communicating with a browser of the particular user.

15. The process according to claim 1, wherein the particular user selects whether the bookmarking is performed locally.

16. The process according to claim 1, wherein the particular user selects whether the bookmarking is performed remotely.

17. The process according to claim 1, wherein the recommendation made in step (g) is displayed to the user.

18. The process according to claim 1, wherein the recommendation in step (g) is made by sound.

19. The process according to claim 1, wherein the bookmarking is performed by a Local Area Network (LAN) in communication with the particular user.

20. The process according to claim 1, wherein the bookmarking is performed by an Internet Service Provider (ISP) of the particular user.

21. The process according to claim 1, further comprising:
(h) confirming with the particular user after a certain predetermined period of time has passed without visitation of the webpage by the particular user whether the bookmark should be removed, and removing the bookmark if the particular user agrees to removal of the bookmark.

22. The process according to claim 1, including:
(h) purging the bookmark after a certain predetermined period of time has passed without visitation of the webpage by the particular user.

23. A process for adaptive bookmarking of often-visited web pages of a web site, comprising the steps of:
(a) determining whether a webpage has been detected;
(b) if the webpage in step (a) has been detected, determining whether the webpage has been previously visited by a particular user;
(c) performing one of (i) creating an initial record of the webpage visit by the particular user if it has been determined in step (b) that the webpage has not been previously visited by the particular user, and (ii) determining whether the webpage has been previously bookmarked if it has been determined in step (b) that the webpage has been previously visited by the particular user;
(d) updating a visitation count if it has been determined in step (b) that the webpage has been previously visited by the particular user;
(e) determining whether the visitation count has reached a predetermined threshold; and
(f) recommending to the user that the webpage be bookmarked if it determined in step (e) that the predetermined threshold of the visitation count has been reached.

24. A process for adaptive bookmarking of often-visited web pages of a web site, comprising the steps of:
(a) determining whether a web page of a web site presently accessed has been previously bookmarked;
(b) determining whether a record count exists if the web page presently accessed has not been bookmarked;
(c) performing one of:
(i) updating the record count to reflect the present access of the web page if it is determined in step (b) that the record count exists; and
(ii) creating an initial record count if it is determined in step (b) that no record count exists for the present webpage being accessed by the particular user;
(d) determining whether the record count has reached a predetermined threshold of visitation that is greater than one visit;
(e) bookmarking the webpage if it is determined in step (d) that the threshold of record counts has been reached.

25. A system for bookmarking often-visited web sites, said system comprising:
a computer having storage;
a browser program in communication with the computer;
a communication means for the computer to communicate with a network;
said browser including a program module that:
(i) determines whether a web site accessed by a particular user has been previously bookmarked, and whether a record exists if the web site has not been previously bookmarked;
(ii) creates a record count identifying the web site accessed being by the particular user; and
(iii) bookmarks the browser to provide a short cut to the web site if a predetermined threshold number of visitation greater than one visit has been reached by the particular user.

26. A system for bookmarking often-visited web sites, said system comprising:
a computer having storage;
a browser program in communication with the computer;
a communication means for the computer to communicate with a network;
said browser including a program module that:
(i) determines whether a web site accessed by a particular user has been previously bookmarked, and whether a record exists if the web site has not been previously bookmarked;
(ii) creates a record count identifying the web site accessed being by the particular user; and
(iii) recommends bookmarking to provide a short cut to the web site if a predetermined threshold number of visitation has been reached by the particular user.

27. The system according to claim 26, wherein the program module includes:
(iv) bookmarking the web site in response to an indication by the user to the recommendation made in step (iii).
